(19) United States
(12) Patent Application Publication
(10) Pub. No.: US 2025/0061666 A1
(43) Pub. Date: Feb. 20, 2025

(54) FLIP-UP/DOWN LOW LIGHT CAMERA FOR AUGMENTED REALITY NIGHT VISION

(71) Applicant: SiOnyx, LLC, Beverly, MA (US)

(72) Inventors: Martin PRALLE, Wayland, MA (US); Robert Walker BABSON, West Lafayette, IN (US)

(21) Appl. No.: 18/802,658

(22) Filed: Aug. 13, 2024

Related U.S. Application Data
(60) Provisional application No. 63/519,307, filed on Aug. 14, 2023.

(51) Int. Cl. G06T 19/00; G02B 27/01

(52) U.S. Cl. CPC G06T 19/006; G02B 27/0172; G02B 27/0176

(57) ABSTRACT

System and methods are provided for augmented reality systems with a combined low light camera and display system that can be selectively flipped or translated into a user's visual line-of-sight for low light operations and counter-flipped or counter-translated out of place to allow for normal daylight vision. In certain implementations, the camera and/or the display system may be selectively attached or detached from eyewear or goggles. The camera and display may be positioned to reduce or eliminate parallax.

### CROSS-REFERENCE TO RELATED APPLICATIONS

This application claims priority to U.S. Provisional Patent Application No. 63/519,307, filed Aug. 14, 2023, the contents of which are incorporated herein by reference as if presented in full.

### FIELD OF THE DISCLOSED TECHNOLOGY

The disclosed technology generally relates to augmented reality systems, and more particularly to an augmented reality system with a combined low light camera and display system that can be selectively flipped into a user's visual line-of-sight for low light operations and flipped out of place to allow for normal daylight vision. The camera and display may be positioned to reduce or eliminate parallax.

### BACKGROUND

Augmented Reality (AR) systems are being deployed for many applications including manufacturing, engineering, healthcare, education, etc. AR devices all share some common characteristics including some form of “see through” transparent display, combined with cameras and other sensors that display information to the user that is “overlayed” onto the transparent observable screen. This general approach has been demonstrated by many systems including: Hololens and Hololens 2, Magic Leap 2, DigiLens ARGO, Apple Vision Pro, XREAL, and Vuzix to name a few. In all cases, the cameras are positioned on the periphery of the see-through display so as to not obstruct the viewing of the real-world scene through the transparent display.

FIG. 1 illustrates a parallax issue associated with conventional augmented reality systems in which a camera is offset from the optical axis of the eye of the observer to avoid obstructing a real-world view through a transparent display. When the image/video captured by the camera is displayed on the transparent display, the resulting parallax (due to the camera offset) causes objects in transparent display image to be offset from the corresponding real-world objects.

When cameras are not aligned with the optical axis of the eye of the observer, there will be a parallax error and the displayed image of the camera will not line up with the real world. It is understood that there are many approaches to the position of the camera with respect to the display. In some instances, the camera is positioned directly above the display. In other instances, the camera is positioned at the outer or inner edge of the display.

FIG. 2A is an example conventional virtual reality goggle system that uses cameras to capture real-world images and project the images onto displays that are not see-through. In these systems it is common to optically position the camera at the same position as the eyeball's optical axis to avoid parallax error. However, virtual reality systems such as these do not allow see-through displays.

FIG. 2B is an example of a conventional augmented reality goggle system having cameras positioned above a see-through display to avoid obstructing direct see-through functions of the system. In such systems, the parallax due to the camera offset causes objects in transparent display image to be offset from the corresponding real-world objects.

As illustrated in FIG. 2A and FIG. 2B, the cameras in AR systems are offset from the optical axis of the eye of the observer. In these systems it is common to optically position the camera at the same position as the eyeball's optical axis to avoid parallax error.

Current Virtual Reality (VR) systems optically position the camera at the same position as the eyeball optical axis, which therefore avoids parallax error. However, Virtual Reality systems do not allow see through displays.

FIG. 2C is an example of a conventional system in which a beam splitter may be used to optically overlay imaging information, sensor data, etc., onto an observed scene. In such systems, the parallax due to the camera offset causes objects in transparent display image to be offset from the corresponding real-world objects. FIG. 2C illustrates combined night-vision and AR technology that was recently developed for the IVAS (Integrated Visual Augmentation System) by Microsoft or the ENVG-B (Enhanced Nightvision Goggle-binocular) system from L3-Harris or Elbit America. In the IVAS system, a see-through optic is combined with a transparent display and cameras to project augmented reality data overlayed on the scene to the user. Similarly, the ENVG-B system uses a beam splitter to optically overlay the thermal imaging information and other sensor data onto the user observed scene.

In the IVAS system, the see through display is positioned in front of the eyes of the user and then cameras are positioned above the display to avoid obstructing the direct see-through functions of the system. A major consequence of this approach is that the optical axes of the cameras are not co-located with the optical axes of the human eyes of the observer. As a result, there is a physical offset between the camera and the eye of the observer. This offset creates a parallax error between the camera image and the human observed image, as illustrated in FIG. 1. If the camera image is directly displayed onto the see-through display, there will be error and objects in the real world will not line up to their position as shown on images in the display.

In AR systems (including the IVAS system), the system is typically calibrated to correct for the parallax error by shifting the image such that it matches the real-world image. However, a computational correction can never solve for all scenarios. Typically, parallax corrections are 2-point corrections that work in 2 different regimes. As such, the parallax corrections will always have some error.

There is a need for improved systems and methods for augmented reality systems with reduced parallax that can be used for low-light applications.

### BRIEF SUMMARY

In accordance with certain implementations of the disclosed technology, a day/night vision camera system is provided. The system can include a low light camera capable of capturing images in daylight conditions, a see-thru display, and a flip-up or flip-down mechanism for the low light camera and see-thru display to stow away out of view during daylight conditions, and wherein the flip-up or flip-down mechanism is configured to flip the low light camera and see-through display to align with a user's eye optical axis for night vision during nighttime condition, wherein aligning the low light camera and see-through display with the user's eye optical axis reduces or eliminates the need for parallax correction.

Certain implementations of the disclosed technology include day/night vision camera system that includes a camera capable of capturing images in a low light condition, a display coupled to an output of the camera, and a moveable mechanism coupled to the camera. In certain implementations, the moveable mechanism may allow the camera to be rotatable or translatable independent of the display. In certain implementations, the moveable mechanism may be operable to selectively rotate or translate the camera to a first position to stow the camera out of view during a daylight condition. In certain implementations, the moveable mechanism may be operable to selectively counter-rotate or counter-translate the camera to a second position to align the camera with a user's eye optical axis for the low-light condition. In certain implementations, the first position may be a flip-up position, and the second position may be flip-down position. In other implementations, the first position may be a flip-down position, and the second position may be a flip-up position. In certain implementations, the first position may be an out-of-the optical axis position, and the second position may be a translation to the optical axis position. In other implementations, the first position may be in the optical axis, and the second position may be a translation to an out-of-the optical axis position.

In accordance with certain implementations of the disclosed technology, a compact fused module for stereoscopic imaging system is provided. The system can include two thermal cameras, two low light cameras, a display, and a flip-up or flip-down mechanism configured to stow away the two thermal cameras, the two low light camera and the display out of view during daylight conditions, wherein the flip-up or flip-down mechanism is configured to selectively align the compact fused module with a user's eye optical axis for night vision during nighttime condition and to reduce or eliminate the need for parallax correction.

In accordance with certain implementations of the disclosed technology, a method is provide that can include stowing a combined low-light camera and display during a daylight conditions by selectively rotating or translating the combined low-light camera and display to a first position out of a user's line of sight; and selectively counter-rotating or counter-translating the combined low-light camera and display to a second position aligned with a user's eye optical axis for low-light conditions.

Certain implementations of the disclosed technology will now be described with the aid of the following drawings and the detailed description.

### BRIEF DESCRIPTION OF THE DRAWINGS

FIG. 1 illustrates a parallax issue associated with conventional augmented reality systems in which a camera is offset from the optical axis of the eye of the observer to avoid obstructing a real-world view through a transparent display.

FIG. 2A is an example conventional virtual reality goggle system that uses cameras to capture real-world images and project the images onto displays that are not see-through.

FIG. 2B is an example of a conventional augmented reality goggle system having cameras positioned above a see-through display to avoid obstructing direct see-through functions of the system.

FIG. 2C is an example of a conventional augmented reality goggle system in which a beam splitter may be used to optically overlay imaging information, sensor data, etc., onto an observed scene.

FIG. 3A is an example illustration of a selectively configurable flip-up/down combined co-linear camera and display system in accordance with certain exemplary implementations of the disclosed technology.

FIG. 3B is an example illustration of a selectively configurable flip-up/down combined co-linear camera and display system 300 in accordance with certain exemplary implementations of the disclosed technology.

FIG. 3C is an example illustration of a selectively configurable flip-up/down combined camera and display system 301 shown in a first position and having a moveable mechanism that allows the camera to be rotated/translated independent of the display, in accordance with certain exemplary implementations of the disclosed technology.

FIG. 3D is an example illustration of a selectively configurable flip-up/down combined camera and display system 301 shown in a second position and having a moveable mechanism that allows the camera to be rotated/translated independent of the display, in accordance with certain exemplary implementations of the disclosed technology.

FIG. 4 is an example illustration of another selectively configurable flip-up/down combined co-linear camera and display system in accordance with certain exemplary implementations of the disclosed technology.

FIG. 5A is an example illustration of a selectively translatable combined co-linear camera and display system in a first position, in accordance with certain exemplary implementations of the disclosed technology.

FIG. 5B is an example illustration of a selectively translatable combined co-linear camera and display system in a second position, in accordance with certain exemplary implementations of the disclosed technology.

FIG. 6 is an example illustration of compact modules that may be utilized, in accordance with certain exemplary implementations of the disclosed technology.

FIG. 7 is a block diagram of an augmented reality system in accordance with certain exemplary implementations of the disclosed technology,

FIG. 8 is a flow diagram of a method, in accordance with certain implementations of the disclosed technology.

FIG. 9A is an example illustration of a selectively attachable/detachable combined co-linear camera and display system in a detached position, in accordance with certain exemplary implementations of the disclosed technology.

FIG. 9B is an example illustration of a selectively attachable/detachable combined co-linear camera and display system in an attached position, in accordance with certain exemplary implementations of the disclosed technology.

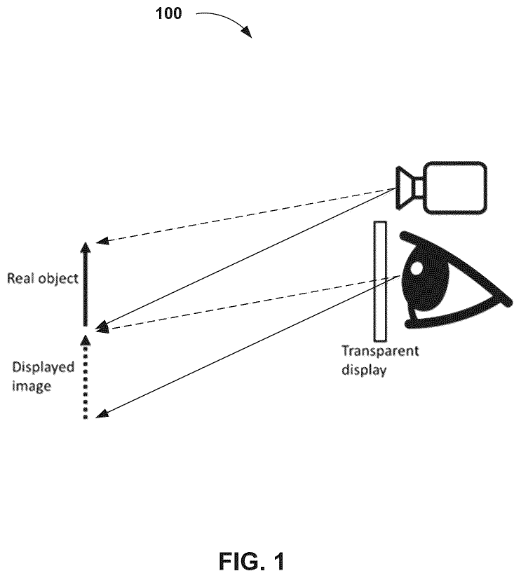

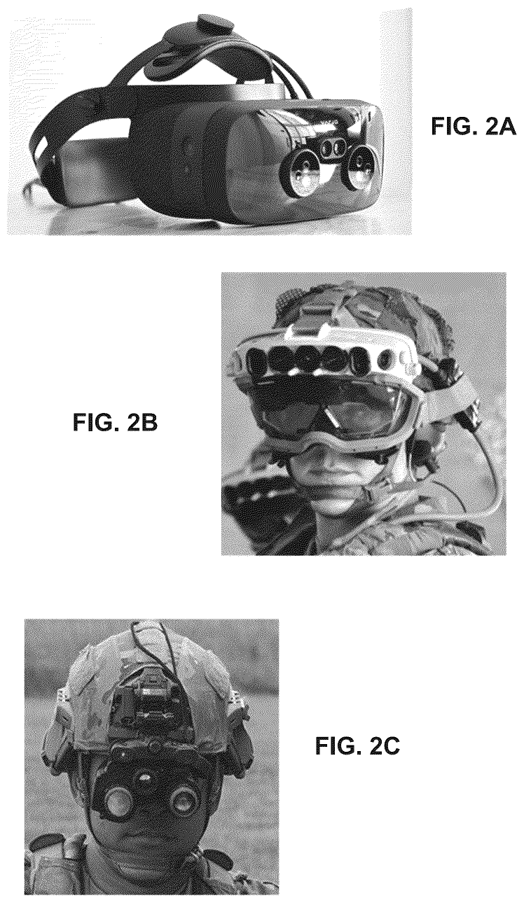

The disclosed technology will now be described using the detailed description in conjunction with the drawings and the attached claims.

### DETAILED DESCRIPTION

The disclosed technology includes a flip-up/down mechanism with a camera and display that may be selectively positioned out of the way or removed or to be selectively positioned to align with a user's eye optical axis to reduce or eliminate parallax. The disclosed technology may be used in augmented reality system. Certain implementations of the disclosed technology include combined low light camera and display system that can be selectively flipped into a user's visual line-of-sight for low light operations and flipped out of place to allow for normal daylight vision.

In daylight conditions, the need for low light cameras may not be required and the system can be flipped out of the user's line of sight. In nighttime conditions the need for see-thru display may not be required because the low light environment cannot be imaged by the naked eye. Therefore, in certain implementations, the disclosed technology may include a mechanical solution to parallax correction. In daytime scenes, the system (with the low light camera and display) can flip out of the user's line of sight. Then, in nighttime conditions, the system (with the low light camera and display) can be flipped into place so that the low light camera is in line with the eye optical axis to enable night vision. In this approach no parallax correction is needed as the low light camera optical axis matches the native eye.

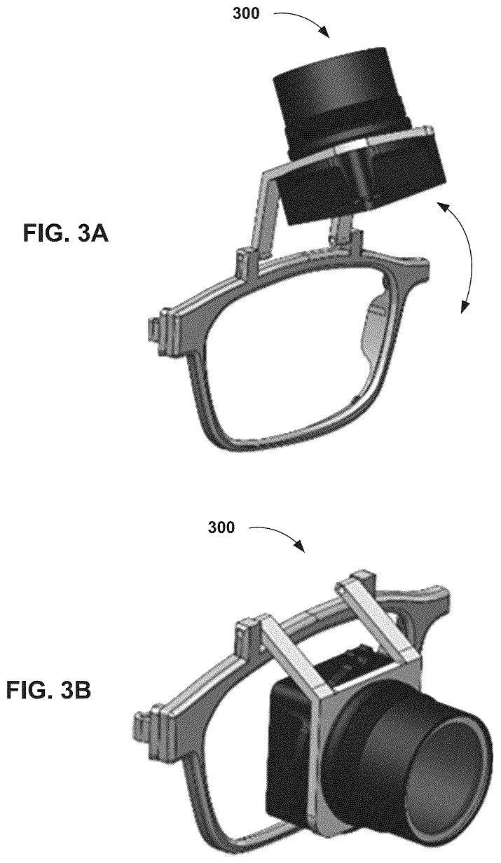

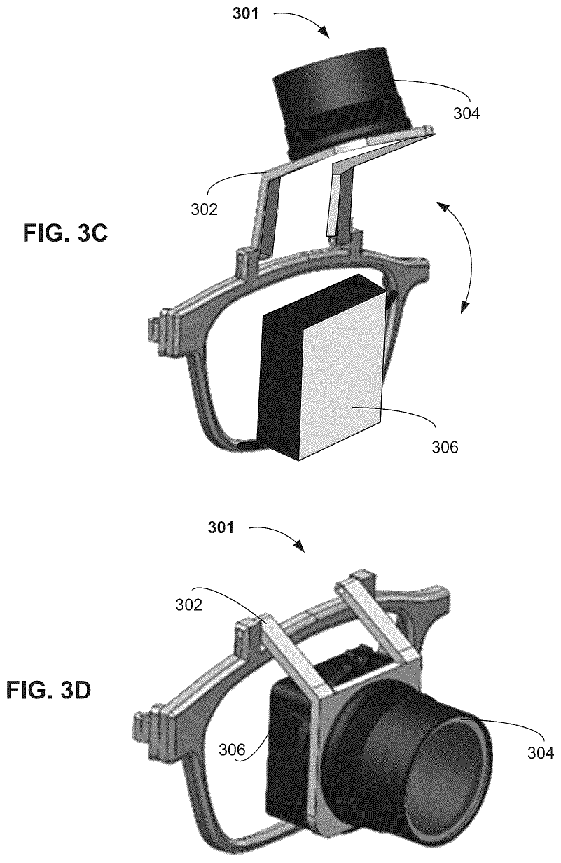

FIG. 3A is an example illustration of a selectively configurable flip-up/down combined co-linear camera and display system in accordance with certain exemplary implementations of the disclosed technology. In this illustration, the system is configured (flipped-up) to be out of a user's visual line-of sight to not obstruct normal viewing.

FIG. 3B is an example illustration of a selectively configurable flip-up/down combined co-linear camera and display system 300 in accordance with certain exemplary implementations of the disclosed technology. In this illustration, the system is selectively configured (flipped-down) to be in-line with a user's visual line-of sight for low-light applications with minimal parallax.

FIG. 3C is an example illustration of a selectively configurable flip-up/down camera 304 and display 306 system 301 shown in a first position and having a moveable mechanism 302 that allows the camera 304 to be rotated/translated independent of the display 306, in accordance with certain exemplary implementations of the disclosed technology. FIG. 3D is an example illustration of the system 301 where the moveable mechanism 302 and attached camera 304 is rotated to a second position for low light conditions.

In certain implementations, the moveable mechanism 302 coupled to the camera 304, allows the camera 304 to be moveable/rotatable/translatable independent of a position of the display 306. Thus, in certain implementations, the moveable mechanism is operable to selectively rotate or translate the camera 304 to a first position to stow the camera 304 out of view during a daylight condition (as illustrated in FIG. 3C), and to selectively counter-rotate or counter-translate the camera 304 to a second position to align the camera 304 with a user's eye optical axis for the low-light condition, as illustrated in FIG. 3D.

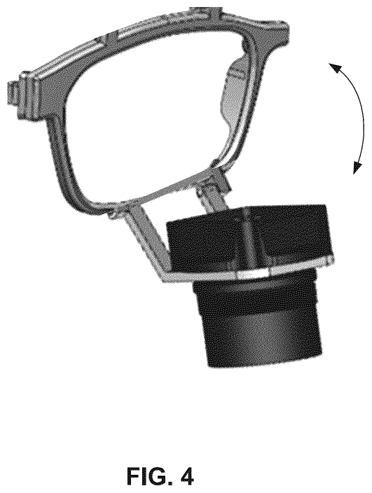

FIG. 4 is an example illustration of another selectively configurable flip-up/down combined co-linear camera and display system 300 in accordance with certain exemplary implementations of the disclosed technology. In this illustration, the system can be flipped-down to be out of a user's visual line-of sight so as to not obstruct normal viewing but can be flipped up to be in-line with a user's visual line-of sight for low-light applications.

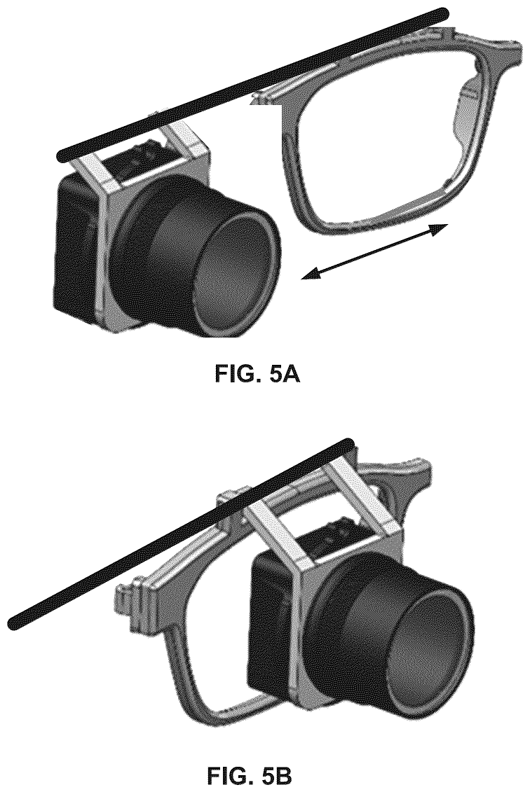

FIG. 5A is an example illustration of a selectively translatable combined co-linear camera and display system in a first position, in accordance with certain exemplary implementations of the disclosed technology.

FIG. 5B is an example illustration of a selectively translatable combined co-linear camera and display system in a second position, in accordance with certain exemplary implementations of the disclosed technology.

It should be understood that example figures FIGS. 3A, 3B, 3C, 3D, 4, 5A, 5B, 9A, and 9B are illustrated for only one eye, but it is possible to have two of these assemblies, one for each eye.

Certain implementations of the disclosed flip-up/down camera/display system can be implemented using a hinge or a flex circuit or a cable or a magnetic connection. For example, when the camera is flipped or translated into place for low light conditions, it can be held in place by a clip or other retaining feature. When the camera is counter-flipped or counter-translated out of the user's line of sight, it can be held in place by a clip, or magnet.

In certain implementations, when the camera is flipped or translated into place for low-light viewing, one or more electrical pogo pins may contact a corresponding electrical connection pad to enable electrical contact to supply power to the corresponding camera/display system.

In another embodiment, the camera/display system may be held into position using a strong magnet. In certain implementations, a Hall Effect sensor in the camera may be utilize to sense the magnet once in position. In this implementation, the Hall Effect sensor may provide a signal to automatically turn on the power to the camera/display system when it is selectively flipped into place for low light use.

In certain implementations, the camera/display system can include a flex circuit in the hinge (or translation rail) region that may be mechanically compliant and still provide the flip up/down or translation mobility.

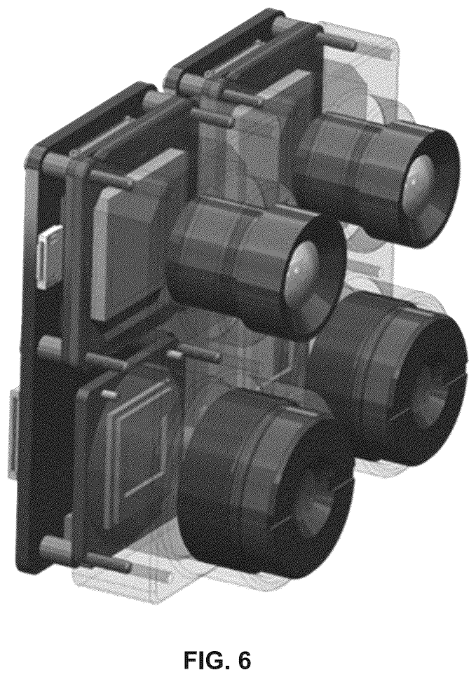

FIG. 6 is an example illustration of compact fused modules that may be utilized, in accordance with certain exemplary implementations of the disclosed technology. In this approach, two thermal cameras (upper) and two low light cameras/displays (lower) may be utilized for stereoscopic imaging. In accordance with certain exemplary implementations of the disclosed technology, these compact fused modules may be used with a flip-up/down or translation mechanism, as discussed above and as illustrated in FIGS. 3A, 3B, 3C, 3D, 4, 5A, and/or 5B. These low light cameras/displays may be aligned with the eye's optical axis so that only vertical parallax correction is needed for the thermal image channels. In accordance with certain exemplary implementations of the disclosed technology, the compact fused module may enable stereoscopic imaging for both low light and thermal and the only parallax correction may be needed to correct vertical offset for the thermal channel. As this will be only 20-25 mm vertically, the parallax correction may only be needed for imaging ranges of less than 5 m where the parallax offset exceeds 5 pixels.

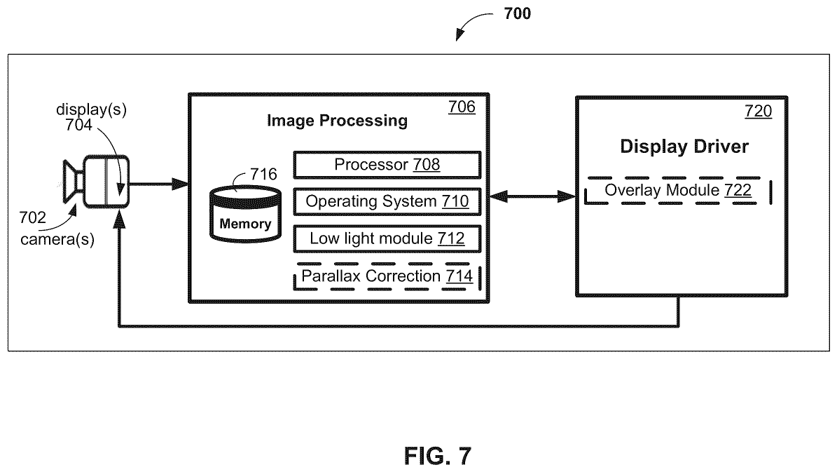

FIG. 7 is a block diagram of an augmented reality system 700 in accordance with certain exemplary implementations of the disclosed technology. In certain implementations, the system 700 can include modular camera(s) 702 and display(s) 704. The camera(s) 702 may be in communication with an image processing module 706. The display(s) 704 may be in communication with a display driver module 720. In certain implementations, the image processing module 706 may include a processor 706, an operating system 710, and a low light processing module 712. In certain implementations where parallax correction is needed, the image processing module 706 may include a parallax correction module 714.

In certain implementations, the display driver module 720 may be configured to take the (video) images processed by the image processing module 706 and drive the display(s) 704. In certain implementations, the display driver module 720 can include an overlay module 722, for example, for overlaying additional information on the display(s) 704.

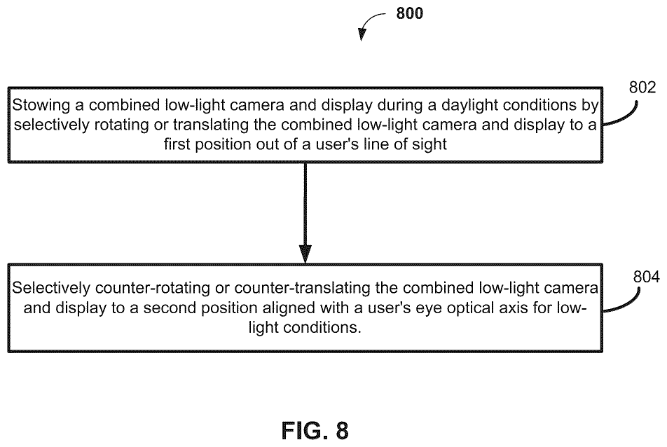

FIG. 8 is a flow diagram of a method 800, in accordance with certain implementations of the disclosed technology. In block 802, the method includes stowing a combined low-light camera and display during daylight conditions by selectively rotating or translating the combined low-light camera and display to a first position out of a user's line of sight. In block 804, the method includes selectively counter-rotating or counter-translating the combined low-light camera and display to a second position aligned with a user's eye optical axis for low-light conditions.

Certain implementations of the disclosed technology may include selectively securing the combined low-light camera and display at the first position or the second position using one or more latching mechanisms.

Certain implementations of the disclosed technology include a day/night vision camera system that can include a low light camera capable of capturing images in daylight conditions, a sec-thru display, a flip-up or flip-down mechanism for the low light camera and see-thru display to stow away out of view during daylight conditions, and wherein the flip-up or flip-down mechanism is configured to flip the low light camera and see-through display to align with a user's eye optical axis for night vision during nighttime condition, wherein aligning the low light camera and see-through display with the user's eye optical axis reduces or eliminates the need for parallax correction.

In certain implementations, no parallax correction is required in nighttime conditions.

In certain implementations, the flip-up or flip-down mechanism may utilize a hinge or a flex circuit or a magnetic connection to hold the low light camera in a stowed position during daylight conditions.

In certain implementations, the flip-up or flip-down mechanism may utilize a clip or a magnet to hold the low light camera in a position aligned with the user's eye optical axis during nighttime conditions.

Certain implementations of the disclosed technology can include electrical pogo pins that enable electrical contact with the low light camera to power the low light camera and see-thru display when it is into position for nighttime conditions.

Certain implementations of the disclosed technology can include a Hall Effect sensor integrated into the low light camera and capable of sensing the presence of a magnet to initiate supplying power to the camera and see-thru display.

In accordance with certain exemplary implementations of the disclosed technology, a compact fused module for stereoscopic imaging is provided that can include two thermal cameras, two low light cameras, a display, and a flip-up or flip-down mechanism configured to stow away out of view during daylight conditions, the two thermal cameras, the two low light camera and the display, wherein the flip-up or flip-down mechanism is configured to selectively align the compact fused module with a user's eye optical axis for night vision during nighttime condition and to reduce or eliminate the need for parallax correction.

In certain implementations, vertical parallax correction may be limited to 20-25 mm, applicable for imaging ranges of less than 5 meters where the parallax offset exceeds 5 pixels.

Certain implementations of the disclosed technology include can include a compliant flex circuit in the hinge region, providing flip-up/flip-down mobility for the low light cameras.

In certain implementations, vertical parallax correction may be achieved through a mechanical offset adjustment for the thermal cameras.

Certain implementations of the disclosed technology include can include a moveable mechanism coupled to the two thermal cameras, the two low light camera and the display, wherein the moveable mechanism is operable to rotate or translate to a first position to stow the low light cameras and display out of view during a daylight condition, and wherein the moveable mechanism is operable to counter-rotate or counter-translate to a second position where the low light cameras are aligned with a user's eye optical axis for the low-light condition.

In certain implementations, the two thermal cameras may be vertically offset from the two light cameras about 20-25 mm, respectively.

In certain implementations, the at least one processor may be configured to correct parallax correction for at least the two thermal cameras. In certain implementations, the parallax correction may comprise vertical parallax correction.

In certain implementations, the at least one processor may be configured to correct parallax correction for at least the two thermal cameras for imaging ranges of less than 5 meters where the parallax offset exceeds 5 pixels.

In certain implementations, the moveable mechanism may include a compliant flex circuit in a hinge region.

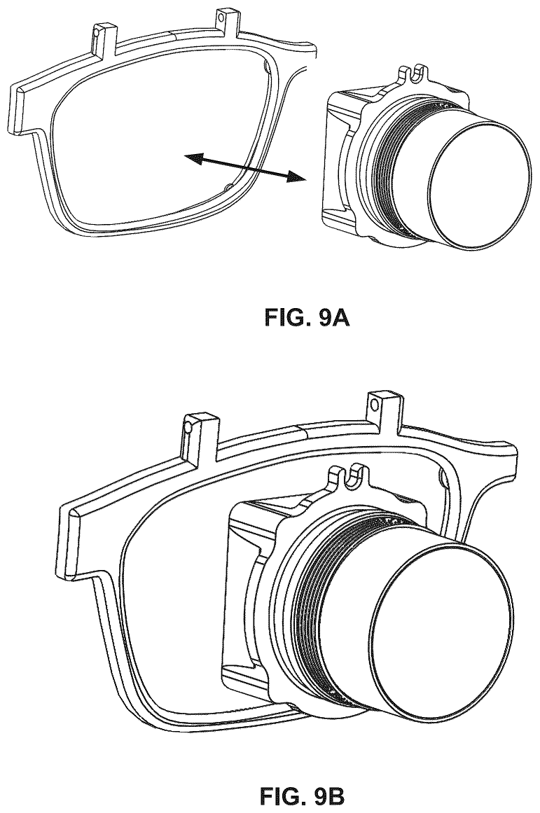

FIG. 9A is an example illustration of a selectively attachable/detachable combined co-linear camera and/or display system in a detached position, in accordance with certain exemplary implementations of the disclosed technology.

FIG. 9B is an example illustration of a selectively attachable/detachable combined co-linear camera and/or display system in an attached position, in accordance with certain exemplary implementations of the disclosed technology. In certain implementations, the attachable/detachable combined co-linear camera and/or display system may be attached to the eyewear frame via suction cups, clips, etc. (not shown). In certain implementations, an attachable/detachable connector (not shown) may be attached to the attachable/detachable combined co-linear camera and/or display system in the attached position, for example, to supply power. In some implementations, one or more pogo-pins may be utilized to supply power to the camera/display.

The illustrations of FIG. 9A and FIG. 9B show that the camera (and/or display system) can be independently installed or removed, according to certain implementations.

Certain implementations of the disclosed technology include method of automatic parallax correction that can include receiving an indication of vertical offset between a thermal camera and a low light camera, detecting or receiving an indication of an imaging range, automatically correcting parallax in a processed image based one or more of the vertical offset between a thermal camera and a low light camera and the imaging range; and outputting the processed image to a display.

Certain implementations of the disclosed technology include day/night vision camera system that includes a camera capable of capturing images in a low light condition, a display coupled to an output of the camera, and a moveable mechanism coupled to the camera. In certain implementations, the moveable mechanism may be moveable/rotatable/translatable or removeable independent of the display. In certain implementations, the moveable mechanism may be operable to selectively rotate or translate to a first position to stow the camera out of view during a daylight condition. In certain implementations, the moveable mechanism may be operable to selectively counter-rotate or counter-translate to a second position to align the camera with a user's eye optical axis for the low-light condition. In certain implementations, the first position may be a flip-up position, and the second position may be flip-down position. In other implementations, the first position may be a flip-down position, and the second position may be a flip-up position.

In certain implementations, the day/night vision camera system can include one or more of the following: a hinge, a flex circuit, a magnetic connection configured to detachably hold the camera in one or more of the first position and the second position, one or more electrical pogo pins that enable electrical contact between the camera and a power source to power the camera when the camera is rotated to the second position; and/or a Hall Effect sensor integrated into the camera and capable of sensing a presence of a magnet to initiate a supply of power to one or more of the camera and the display.

Certain implementations of the disclosed technology include can include a computer-readable storage medium storing instructions that, when executed by a processor, causes the processor to perform a method of automatic parallax correction including receiving an indication of vertical offset between a thermal camera and a low light camera, detecting or receiving an indication of an imaging range, automatically correcting parallax in a processed image based one or more of the vertical offset between a thermal camera and a low light camera and the imaging range, and outputting the processed image to a display.

Implementations of the subject matter and the functional operations described herein may be implemented in various systems, digital electronic circuitry, computer software, firmware, or hardware, including the structures disclosed herein and their structural equivalents, or in combinations of one or more of them. Implementations of the subject matter described herein can be implemented as one or more computer program products, i.e., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter affecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flow described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media, and memory devices, including by way of example semiconductor memory devices, e.g., EPROM, EEPROM, flash memory devices. The processor and the memory can be supplemented by, or incorporated into, special-purpose logic circuitry.

While this disclosure includes many specifics, these should not be construed as limitations on the scope of any of the disclosure or of what may be claimed, but rather as descriptions of features that may be specific to particular embodiments of particular inventions. Certain features that are described in the context of separate embodiments can also be implemented in combination in a single implementation. Conversely, various features that are described in the context of a single implementation can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described herein should not be understood as requiring such separation in all embodiments.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the disclosed technology.

We claim:

1. A day/night vision camera system comprising:
a camera capable of capturing images in a low light condition;
a display coupled to an output of the camera;
a moveable mechanism coupled to the camera and display, wherein the moveable mechanism has a flip-up position to stow the camera and display out of view during a daylight condition and a flip-down position where the camera is aligned with a user's eye optical axis for the low light condition.

2. The day/night vision camera system of claim 1, wherein the moveable mechanism further comprises a hinge, a flex circuit, or a magnetic connection configured to detachably hold the camera in the flip-up position.

3. The day/night vision camera system of claim 1, wherein the moveable mechanism further comprises a clip or a magnet to detachably hold the camera in the flip-down position where the camera is aligned with the user's eye optical axis for the low light condition.

4. The day/night vision camera system of claim 1, further comprising electrical pogo pins that enable electrical contact between the camera and a power source to power the camera and display when in the low light condition.

5. The day/night vision camera system of claim 1, further comprising a Hall Effect sensor integrated into the camera and capable of sensing a presence of a magnet to initiate a supply of power to the camera and display.

6. A compact fused module for stereoscopic imaging comprising:
two thermal cameras;
two low light cameras;
a display;
at least one processor;
a moveable mechanism coupled to the two thermal cameras, the two low light camera and the display, wherein the moveable mechanism is operable to rotate or translate to a first position to stow the low light cameras and display out of view during a daylight condition, and wherein the moveable mechanism is operable to counter-rotate or counter-translate to a second position where the low light cameras are aligned with a user's eye optical axis for a low light condition.

7. The compact fused module of claim 6, wherein the two thermal cameras are vertically offset from the two low light cameras about 20-25 mm, respectively.

8. The compact fused module of claim 7, wherein the at least one processor is configured to correct parallax correction for at least the two thermal cameras.

9. The compact fused module of claim 8, wherein the parallax correction comprises vertical parallax correction.

10. The compact fused module of claim 7, wherein the at least one processor is configured to correct parallax correction for at least the two thermal cameras for imaging ranges of less than 5 m where the parallax offset exceeds 5 pixels.

11. The compact fused module of claim 6, wherein the moveable mechanism further comprises a compliant flex circuit in a hinge region.

12. A method, comprising:
stowing a combined low-light camera and display during daylight conditions by selectively rotating or translating the combined low-light camera and display to a first position out of a user's line of sight; and
selectively counter-rotating or counter-translating the combined low-light camera and display to a second position aligned with a user's eye optical axis for low-light conditions.

13. The method of claim 12, further comprising one or more latching mechanisms configured to selectively secure the combined low-light camera and display at the first position or the second position.

14. A method of automatic parallax correction, comprising:
receiving an indication of vertical offset between a thermal camera and a low light camera;
detecting or receiving an indication of an imaging range;
automatically correcting parallax in a processed image based one or more of the vertical offset between a thermal camera and a low light camera and the imaging range; and
outputting the processed image to a display.

15. A day/night vision camera system, comprising:
a camera capable of capturing images in a low light condition;
a display coupled to an output of the camera; and
a moveable mechanism coupled to the camera, wherein the moveable mechanism is configured to move the camera independent of a position of the display, wherein the moveable mechanism is operable to selectively rotate or translate the camera to a first position to stow the camera out of view during a daylight condition, and wherein the moveable mechanism is operable to selectively counter-rotate or counter-translate the camera to a second position to align the camera with a user's eye optical axis for the low light condition.

16. The day/night vision camera system of claim 15, wherein the first position is a flip-up position, and the second position is a flip-down position.

17. The day/night vision camera system of claim 15, wherein the first position is a flip-down position, and the second position is a flip-up position.

18. The day/night vision camera system of claim 15, further comprising one or more of:
a hinge;
a flex circuit;
a magnetic connection configured to detachably hold the camera in one or more of the first position and the second position;
one or more electrical pogo pins that enable electrical contact between the camera and a power source to power the camera when the camera is rotated to the second position; and
a Hall Effect sensor integrated into the camera and capable of sensing a presence of a magnet to initiate a supply of power to one or more of the camera and the display.
